(19) United States
(12) Patent Application Publication
(10) Pub. No.: US 2026/0155527 A1
(43) Pub. Date: Jun. 4, 2026

(54) Explosion-Proof Valve for a Power Battery and Power Battery

(71) Applicant: Mercedes-Benz Group AG, Stuttgart (DE)

(72) Inventor: Xiaowei HU, Beijing (CN)

(21) Appl. No.: 18/707,442

(22) PCT Filed: Oct. 10, 2022
(86) PCT No.: PCT/CN2022/124338

§ 371 Date: May 3, 2024

(30) Foreign Application Priority Data
Nov. 4, 2021 (CN) 202111300070.5

(51) Int. Cl. H01M 50/342; H01M 50/30; H01M 50/308; H01M 50/367

(52) U.S. Cl. CPC H01M 50/3425; H01M 50/308; H01M 50/367; H01M 50/394

(57) ABSTRACT

An explosion-proof valve for a power battery includes a main valve body which has at least one gas outlet, a plurality of gas inlets, and a plurality of valve opening units that are respectively disposed in the plurality of gas inlets. At least two of the plurality of gas inlets are each in communication with a one of the at least one gas outlet in an opened state of the respective valve opening units such that at least two gas channels are formed. The at least two of the plurality of gas inlets block communication of the at least two of the plurality of gas inlets with an external environment of the power battery in a closed state of the respective valve opening units.

### BACKGROUND AND SUMMARY OF THE INVENTION

This invention relates to an explosion-proof valve for a power battery, in particular to an explosion-proof valve for a ternary battery. The invention further relates to a power battery with the explosion-proof valve.

With the progress of vehicle electrification, the automotive consumer market has stricter requirements for the range of electric vehicles, which leads the industry to develop in the direction of high-energy density power battery packs. Therefore, the ternary chemical system and even the high-nickel ternary chemical system have been increasingly applied to the research and development of power batteries. However, high-energy density battery packs of the ternary system also bring more serious challenges in terms of safety performance, in particular in the case of thermal runaway of a single cell in a power battery pack, the thus released heat will be spread and transferred to the rest of the single cells in the power battery pack, causing thermal runaway of other cells, and this phenomenon is usually referred to as thermal propagation of power batteries.

For power battery packs of the ternary system, the thermal propagation test is very strict. When a single cell in the battery pack has a thermal runaway, the cell will cause a violent reaction of electrolyte as a result of internal short circuit, releasing a large amount of flammable gas, accompanied by eruption of high-temperature particulates. One of the key points to control and delay the heat propagation in the power battery pack is to discharge the flammable gas from the power battery pack in time and meanwhile effectively filter out high-temperature particulates so as to prevent these high-temperature particulates from igniting the flammable gas in the air.

In the prior art, in order to ensure the safety of the power battery pack, an explosion-proof valve is generally installed on the top cover of the power battery. When the power battery has an accident caused by improper charging, short circuit or exposure to harsh environments such as high temperature, the thus generated large amount of high-temperature gas bursts open the explosion-proof valve to achieve the purpose of depressurization and gas discharge. Owing to the use of explosion-proof valves, the safety performance of batteries has been greatly improved.

Currently, the conventional explosion-proof valve for a power battery is usually composed of a main valve body, an explosion-proof diaphragm, and a particulate filter sheet. During the discharge of gas, the particulate filter sheet will gradually become clogged, which reduces the exhaust capacity of the explosion-proof valve. In the end, when the filter sheet is completely clogged, the large amount of flammable gas in the power battery pack cannot be properly discharged, which causes a surge of the pressure in the power battery pack and thus results in a severe explosion phenomenon, and the safety protection function is completely lost.

Therefore, there is still a demand for an explosion-proof valve that is capable of reliably and safely depressurizing and discharging gas for power battery packs.

On this basis, the present invention proposes an efficient solution, which can not only overcome the deficiencies in the existing technical solutions, but also realize a staged and redundant explosion-proof exhaust function through a simple structure, thereby enabling power batteries, in particular ternary batteries, to operate safely and reliably.

According to one aspect of the invention, an explosion-proof valve for a power battery is provided, the explosion-proof valve comprising:
a main valve body, which is provided with at least one gas outlet and a plurality of gas inlets,
wherein a valve opening unit is correspondingly provided in each gas inlet, and at least two of the plurality of gas inlets are each in communication with one of the at least one gas outlet in an opened state of the respective valve opening units, so that at least two gas channels are formed, and the plurality of gas inlets block communication of the corresponding gas inlets with external environment of the power battery in a closed state of the respective valve opening units.

The basic conception of the invention is that, by means of formation of a plurality of gas channels in the main valve body, a multi-stage valve opening structure can be realized without increasing the number of explosion-proof valves, thereby simplifying the installation cost and significantly reducing the need for installation space. In the case where one gas inlet is clogged by particulates and thus cannot discharge gas, leading to an increase in the pressure in the power battery, the other gas inlet can be opened to reliably depressurize the power battery to ensure that during the thermal propagation process, no explosion caused by the high-pressure, high-temperature flammable gas will occur in the power battery, thereby realizing a safe and reliable operation of the power battery. In addition, in the case of thermal propagation of the entire explosion-proof exhaust system in the power battery, it is also possible to open the valves in sequence to relieve pressure and discharge gas.

According to an optional embodiment of the invention, the explosion-proof valve further comprises a particulate filter sheet, which is provided on the main valve body for filtering particulates. Alternatively or additionally, the main valve body is configured to be adapted to be provided on a fixing structure in order to hold the main valve body. Alternatively or additionally, the main valve body comprises a first valve body structure and a second valve body structure, and the first valve body structure is constructed independently of the second valve body structure. By means of the first valve body structure and the second valve body structure, different gas channels and valve opening units corresponding thereto can be realized in a simple manner.

According to another optional embodiment of the invention, the gas outlet is formed on the first valve body structure, and the plurality of gas inlets are formed on the second valve body structure, wherein the particulate filter sheet is provided on the second valve body structure.

According to another optional embodiment of the invention, the first valve body structure is configured in a cylindrical shape and can be inserted into the second valve body structure to form one gas channel of the at least two gas channels. Here, the second valve body structure is correspondingly formed with a receiving portion that matches the cylindrical structure, and the fixing structure is provided thereon with an opening that matches the cylindrical structure, so that the first valve body structure can be inserted through the opening into the receiving portion. In this way, the first valve body structure and the second valve body structure are assembled on the fixing structure. Here, a gas inlet is formed on the receiving portion.

According to another optional embodiment of the invention, an additional opening is provided on the first valve body structure, and the other gas channel of the at least two gas channels is formed through the opening between the gas outlet and the plurality of gas inlets. Here, the gas channel and the other gas channel are independent of each other. A plurality of gas channels thereby can be realized in the explosion-proof valve by a simple configuration of the first valve body structure.

According to another optional embodiment of the invention, the valve opening units for the at least two gas inlets each comprise:
respective needles, at least one of which is provided in the first valve body structure, and at least another one of which is provided in the second valve body structure;
respective diaphragms, which are provided on the second valve body structure and disposed to face the corresponding needle, wherein the at least two gas inlets are closed by the respective diaphragms.

In this way, the opening of valve opening units can be realized in a simple manner. Here, an opening pressure of the valve opening unit may be set based on a material strength of the diaphragm and/or a distance between the diaphragm and the needle so as to flexibly adapt to different pressure conditions in the power battery, or in other words, the opening pressures of the explosion-proof valve.

According to another optional embodiment of the invention, the explosion-proof valve is provided with two gas inlets. Two gas channels are thus formed, and a valve opening unit is provided in each of the two gas channels. Alternatively or additionally, the valve opening units in the at least two gas inlets are designed according to different valve opening pressures and/or different valve opening principles. In this way, a stepwise valve opening structure can be additionally realized, so that the explosion-proof valve can be better adapted to different pressure levels in the power battery.

According to another optional embodiment of the invention, the first valve body structure and/or the second valve body structure is made of a high-temperature-resistant material. In this way, the weight of the entire explosion-proof valve can be reduced while the strength and heat resistance of the valve body are guaranteed. Alternatively or additionally, the diaphragm is made of a high-temperature-resistant material. Alternatively or additionally, the particulate filter sheet is made of a high-temperature-resistant material.

According to another optional embodiment of the invention, screw holes are provided on the first valve body structure and the second valve body structure, and the first valve body structure and the second valve body structure are fixed on the fixing structure by screw connection. In this way, the explosion-proof valve can be detachably fastened to the fixing structure in a simple manner.

According to another optional embodiment of the invention, the fixing structure is a part of a box of the power battery. In this way, the explosion-proof valve can be directly fixed on the box of the power battery without additional fixing components.

According to another aspect of the invention, a power battery is provided, the power battery comprising the explosion-proof valve according to the present invention.

More features of the invention will be apparent from the claims, the drawings and the description of the drawings. Features and feature combinations mentioned above as well as features and feature combinations mentioned in the following description of the drawings and/or shown only in the drawings can be used not only in correspondingly specified combinations, but also in other combinations without deviating from the scope of the invention. Therefore, the following contents are also considered to be covered and disclosed by the present invention: these contents are not explicitly shown in the drawings and are not explicitly explained, but are derived from combinations of separate features from the already explained contents and are generated by these combinations. The contents and feature combinations which do not have all the features of the originally written independent claims are also regarded as being disclosed. Furthermore, the contents and feature combinations which go beyond or deviate from the feature combinations defined in the reference relationships of the claims are in particular regarded as being disclosed by the above contents.

The invention will be described below in greater detail with reference to the accompanying drawings, which leads to a better understanding of the principles, characteristics and advantages of the invention.

### BRIEF DESCRIPTION OF THE DRAWINGS

FIG. 1 shows a perspective view of an explosion-proof valve before assembly according to an exemplary embodiment of the invention;

FIG. 2 shows a bottom view of the explosion-proof valve of FIG. 1 after assembly;

FIG. 3 shows a top view of the explosion-proof valve of FIG. 1 after assembly; and

FIG. 4 schematically shows a side cross-sectional view of the explosion-proof valve of FIG. 1 after assembly.

### DETAILED DESCRIPTION OF THE DRAWINGS

For a clearer understanding of the technical problem to be solved, the technical solutions and advantageous technical effects of the invention, the invention now will be further explained in detail in conjunction with the accompany drawings and a number of exemplary embodiments. It should be understood that the specific embodiments described herein are merely for the purpose of explaining, rather than limiting the scope of protection of the invention.

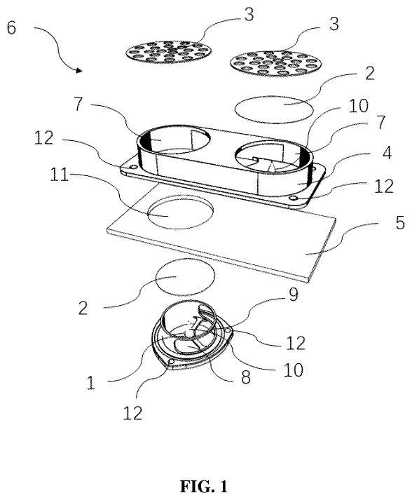

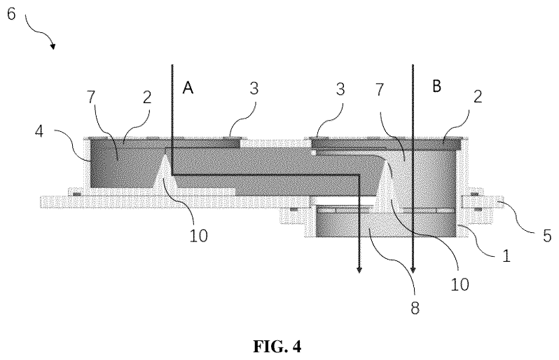

FIG. 1 shows a perspective view of an explosion-proof valve before assembly according to an exemplary embodiment of the invention. In this exemplary embodiment, an explosion-proof valve 6 comprises a main valve body having a first valve body structure 1 and a second valve body structure 4, wherein the first valve body structure 1 is constructed independently of the second valve body structure 4. In addition, the main valve body, or the first valve body structure 1 and the second valve body structure 4, can be fixed to a fixing structure 5. The fixing structure 5 may be directly fixed to a box of the power battery as a separate component or, according to another exemplary embodiment, be constructed as a part of the box of the power battery. In addition, the explosion-proof valve 6 further comprises particulate filter sheets 3, which are respectively disposed on the second valve body structure 4 and are configured to filter particulates. In this exemplary embodiment, the particulate filter sheets 3 are made of a high-temperature-resistant material. An only gas outlet 8 is formed on the first valve body structure 1, and two gas inlets 7 are exemplarily formed on the second valve body structure 4. In addition, an opening 9 is additionally provided on the first valve body structure 1, which opening corresponds to one of the two gas inlets 7. In this way, two gas channels A and B (see FIG. 4) independently of each other are formed between the only gas outlet 8 and the two gas inlets 7. In this exemplary embodiment, the first valve body structure 1 is arranged in the second valve body structure 4, and a valve opening unit is correspondingly provided in each gas inlet 7. According to an exemplary embodiment, the valve opening units comprise needles 10, which are arranged in the first valve body structure 1 and the second valve body structure 4, respectively. The valve opening units further comprise diaphragms 2, which are respectively provided on the second valve body structure 4 and are respectively disposed to face the needle 10. The two gas inlets 7 can be closed by the respective membranes 2.

According to the exemplary embodiment of FIG. 1, the first valve body structure 1 is configured in a cylindrical shape, a cylindrical receiving portion that matches the cylindrical structure of the first valve body structure 1 is provided on the second valve body structure 4, and the fixing structure 5 is correspondingly provided with an opening 11 that matches the cylindrical structure, so that the first valve body structure 1 can be inserted through the opening 11 into the corresponding receiving portion of the second valve body structure 4 in a simple manner. In one exemplary embodiment, the first valve body structure 1 and the second valve body structure 4 are provided with screw holes 12 for connecting to the fixing structure 5, and by means of screws (not shown) passing through the screw holes, the first valve body structure 1 and the second valve body structure 4 can be respectively fixed on the fixing structure 5.

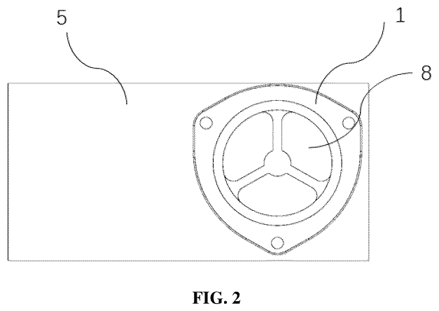

FIG. 2 shows a bottom view of the explosion-proof valve of FIG. 1 after assembly. In this exemplary embodiment, the first valve body structure 1 is inserted through the corresponding opening of the fixing structure 5 into the second valve body structure 4 and is fixedly connected to the fixing structure 5 by means of screws (not shown). A simple assembly manner is thus achieved.

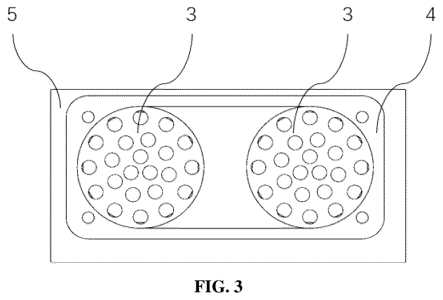

FIG. 3 shows a top view of the explosion-proof valve of FIG. 1 after assembly. As can be seen from FIG. 3, two gas inlets are provided on the second valve body structure 4, and particulates are filtered out by particulate filter sheets 3 arranged thereon before a gas flows through the gas inlets. In an assembled state, the two diaphragms 2 (see FIG. 1) close the two gas inlets 7, respectively.

FIG. 4 schematically shows a side cross-sectional view of the explosion-proof valve of FIG. 1 after assembly. The two gas channels A and B are marked with arrows in FIG. 4. Here, the gas channel A extends from the gas inlet 7, which is arranged away from the first valve body structure 1 and is provided on the second valve body structure 4, through the additional opening 9 (see FIG. 1) arranged on the first valve body structure 1 to the gas outlet 8 arranged on the first valve body structure 1. The gas channel B extends from the other gas inlet 7, which is arranged close to the first valve body structure 1 and is provided on the second valve body structure 4 to the gas outlet 8. Therefore, two gas channels A and B independently of each other are formed in the explosion-proof valve 6, and the two gas channels have different extension lengths. In the case of inaction of the explosion-proof valve 6 or in the assembled state, the gas channels A and B, or the two gas inlets 7, are respectively closed by the diaphragms 2, so that no gas can be discharged from the interior of the power battery through the gas channels A and B to the outside of the power battery.

When the power battery has an accident caused by improper charging, short circuit or exposure to harsh environments such as high temperature, a large amount of high-temperature gas is generated, and the pressure inside the power battery increases. Therefore, the diaphragms 2 are deformed towards the needles 10 as a result of the increased gas pressure in the power battery and are pierced by the needles 10 when a preset pressure is reached, whereby the valve opening units are opened and the gas in the power battery can thus flow from the gas inlets 7 through the gas channels A and B to be discharged to the outside of the power battery.

According to an embodiment of the invention, valve opening pressures of the two valve opening units in the explosion-proof valve 6 are set differently. In other words, as shown in FIG. 4, since the gas channel B has a shorter length than the gas channel A, that is, the path through which a high-temperature gas is discharged out of the gas channel B is shorter than the path through the gas channel A, which means the gas channel B is more conducive to the rapid discharge of high-temperature gas. Therefore, according to this exemplary embodiment, the valve opening pressure where the gas channel B is located is lower than the valve opening pressure where the gas channel A is located so as to ensure that the high-temperature gas can always be discharged from the power battery through the gas channel B first.

With particulates in the high-temperature gas being filtered by the particulate filter sheets 3 and accumulated on the surface of the particulate filter sheets 3, the particulate filter sheets 3 may get clogged by particulates. This will result in the gas channel B, or the corresponding gas inlet 7, being closed again due to clogging, even if the corresponding valve opening unit, or diaphragm 2, has been pierced by the needle 10. In this case, the temperature and pressure inside the power battery rise again, and when the valve opening pressure of the gas channel A, or the corresponding other valve opening unit, is reached, the corresponding diaphragm 2 is pierced by the needle 10, whereby the corresponding other valve opening unit is opened and the high-temperature gas can be discharged from the interior of the power battery via the gas channel A as an alternative. Therefore, even when one gas channel B is clogged, the high-temperature gas can still be reliably discharged through the other valve opening unit. This greatly improves the operational safety of the power battery and thus the electric vehicle.

In an alternative exemplary embodiment, the gas channel A and the gas channel B may be opened simultaneously or in sequence, depending on the setting of the valve opening pressures of the valve opening units.

For the skilled person in the art, other advantages and alternative embodiments of the invention are obvious. Therefore, the invention in terms of its broader meaning is not limited to the specific details, representative structures and exemplary embodiments shown and described herein. On the contrary, the skilled person in the art can make various modifications and substitutions without deviating from the essential spirit and scope of the present invention.

1. -11. (canceled)

12. An explosion-proof valve (6) for a power battery, comprising:
a main valve body which has at least one gas outlet (8) and a plurality of gas inlets (7); and
a plurality of valve opening units that are respectively disposed in the plurality of gas inlets (7);
wherein at least two of the plurality of gas inlets (7) are each in communication with a one of the at least one gas outlet (8) in an opened state of the respective valve opening units such that at least two gas channels (A, B) are formed and wherein the at least two of the plurality of gas inlets (7) block communication of the at least two of the plurality of gas inlets (7) with an external environment of the power battery in a closed state of the respective valve opening units.

13. The explosion-proof valve (6) according to claim 12, further comprising a particulate filter sheet (3) disposed on the main valve body for filtering particulates.

14. The explosion-proof valve (6) according to claim 12, wherein the main valve body is configured to be provided on a fixing structure (5).

15. The explosion-proof valve (6) according to claim 12, wherein the main valve body comprises a first valve body structure (1) and a second valve body structure (4) and wherein the first valve body structure (1) and the second valve body structure (4) are separate structures.

16. The explosion-proof valve (6) according to claim 15, further comprising a particulate filter sheet (3) for filtering particulates, wherein the at least one gas outlet (8) is formed on the first valve body structure (1), wherein the plurality of gas inlets (7) are formed on the second valve body structure and wherein the particulate filter sheet (3) is disposed on the second valve body structure

17. The explosion-proof valve (6) according to claim 15, wherein the first valve body structure (1) is configured in a cylindrical shape and is insertable into the second valve body structure (4) to form a first gas channel (A) of the at least two gas channels (A, B).

18. The explosion-proof valve (6) according to claim 17, wherein the first valve body structure (1) defines an opening (9) and wherein a second gas channel (B) of the at least two gas channels (A, B) is formed through the opening (9) between the at least one gas outlet (8) and the plurality of gas inlets (7).

19. The explosion-proof valve (6) according to claim 15, wherein the plurality of valve opening units each comprise:
a needle (10);
wherein a first needle (10) is disposed in the first valve body structure (1) and a second needle (10) is disposed in the second valve body structure (4); and
a diaphragm (2) which is disposed on the second valve body structure (4) and is disposed to face a corresponding needle (10), wherein the at least two gas inlets (7) are closed by the respective diaphragm (2).

20. The explosion-proof valve (6) according to claim 12, wherein the plurality of gas inlets (7) comprise two gas inlets (7) and/or the plurality of valve opening units are configured according to different valve opening pressures and/or different valve opening principles.

21. The explosion-proof valve (6) according to claim 19, further comprising a particulate filter sheet (3) disposed on the main valve body for filtering particulates, wherein the first valve body structure (1) and/or the second valve body structure (4) and/or the diaphragm (2) and/or the particulate filter sheet (3) is made of a high-temperature-resistant material.

22. The explosion-proof valve (6) according to claim 15, wherein the first valve body structure (1) and the second valve body structure have respective screw holes (12) and wherein the first valve body structure (1) and the second valve body structure (4) are fixed on a fixing structure (5) by screws.

23. The explosion-proof valve (6) according to claim 14, wherein the fixing structure (5) is a part of a box of the power battery.

24. A power battery, comprising:
the explosion-proof valve (6) according to claim 12.
